(19) United States
(12) Patent Application Publication
(10) Pub. No.: US 2009/0196460 A1
(43) Pub. Date: Aug. 6, 2009

(54) EYE TRACKING SYSTEM AND METHOD

(76) Inventors: Thomas Jakobs, Alma, AR (US); Allen W. Baker, Bella Vista, AR (US)

Correspondence Address: RADER FISHMAN & GRAUER PLLC, LION BUILDING, 1233 20TH STREET N.W., SUITE 501, WASHINGTON, DC, 20036, US

(21) Appl. No.: 12/357,280

(22) Filed: Jan. 21, 2009

Related U.S. Application Data
(60) Provisional application No. 61/006,514, filed on Jan. 17, 2008.

(51) Int. Cl. G06K 9/00

(52) U.S. Cl. 382/103

(57) ABSTRACT

An eye tracking system and method is provided giving persons with severe disabilities the ability to access a computer through eye movement. A system comprising a head tracking system, an eye tracking system, a display device, and a processor which calculates the gaze point of the user is provided. The eye tracking method comprises determining the location and orientation of the head, determining the location and orientation of the eye, calculating the location of the center of rotation of the eye, and calculating the gaze point of the eye. A method for inputting to an electronic device a character selected by a user through alternate means is provided, the method comprising placing a cursor near the character to be selected by said user, shifting the characters on a set of keys which are closest to the cursor, tracking the movement of the character to be selected with the cursor, and identifying the character to be selected by comparing the direction of movement of the cursor with the direction of movement of the characters of the set of keys which are closest to the cursor.

### CROSS REFERENCE TO RELATED APPLICATIONS

This application claims priority under 35 U.S.C. § 119(e) from co-pending and commonly-owned U.S. Provisional Application No. 61/006,514, filed on Jan. 17, 2008 by Thomas Jakobs and Allen W. Baker, entitled “Eye Tracking Device and Method,” which is incorporated by reference herein in its entirety.

### BACKGROUND OF THE INVENTION

1. Field of the Invention

The present invention relates generally to an eye tracking system and method, and more particularly to an eye tracking system and method for inputting to an electronic device a text character selected by gazing.

2. Description of the Related Art

Many people with severe disabilities are unable to use a standard keyboard and mouse for entering information or controlling a computer. To help these people, devices have been invented that enable a person to control a computer cursor using alternate means, such as head pointing or eye pointing.

Presently available eye pointing and eye tracking systems, such as the systems available from L.C. Technologies, Inc. or Tobii Technology, monitor the position and movement of the user's eye by tracking the center of the pupil and a reflection of light off of a user's cornea, known as a Purkinje reflection.

FIG. 1 shows a schematic of the eye of a user of such system. FIG. 1 shows an eye 10 of the user, an iris 12, a pupil 13, and the pupil center 11. A glint 15 is reflected off the cornea of the user's eye 10. The separation between the pupil center 11 and the glint 15 is utilized in the system to show where the eye is looking.

These systems have significant disadvantages. First, the distance between the pupil center 11 and the glint 15 is very small, as illustrated in FIG. 1. Accordingly, these systems require high-resolution cameras and state-of-the-art image processing algorithms. Such sophistication comes at a high cost. These eye tracking systems cost over $14,000.

Second, because this system monitors light reflected off of the cornea, it is intolerant of lighting changes. This intolerance severely limits the practical application of these systems. Because these systems have a high cost and lack practical application, they have primarily been unavailable to many people with severe disabilities, These systems are generally designed for use in consumer research environments interested in tracking eye movements.

Lower resolution eye gaze systems are also available. The VisionKey product is a camera attached to eyeglasses that tracks pupil movement. The unit retails for approximately $4,000.

Other eye-tracking techniques are known to be in development. In the mid-1990's, researchers at Boston College developed a competing approach to eye tracking based upon the measurement of electrical signals generated by eye movements. As shown in FIG. 2, electrodes 201, 202, 203 in contact with the face of the user measure the electro-oculographic potential. This system has the significant disadvantage that the user is required to wear electrical equipment or accurately place electrodes and the user must be tethered to control boxes and/or computers. This research group has built roughly a dozen of these units over the past several years, and as far as is known, no commercial manufacturer or distributor has adopted this technology.

To provide persons with severe disabilities access to a computer, the above described systems may be used in conjunction with a computer system with software to display an onscreen keyboard and emulate the clicking of a mouse. The above described eye tracking systems may be used to position a cursor for computer control. This software, which usually is displayed on the computer screen in a configuration similar to a standard keyboard, enables the person who is using an alternate access method (e.g. head pointing or eye pointing) to enter keyboard information into the computer and control software applications. FIG. 3 shows a screen shot of an onscreen keyboard that is included with Microsoft Windows XP.

Onscreen keyboards typically work as follows. The user moves the cursor over a key using an alternate access method, for example, head tracking or eye pointing. The user aligns the cursor over a letter on the onscreen keyboard. When the user holds the cursor steady over the letter for a predetermined amount of time (called “dwelling”), the on-screen keyboard software sends the letter to another active software program (for example, a text editor) in the way similar to when a key is pressed on a standard, hardware-based keyboard. As the user targets multiple letters with her head and dwells on them, she can type information into the computer. Under most situations, the computer cursor is actually displayed over the keys in order to select the key.

Special problems occur when using an on-screen keyboard with an eye tracking system. Due to physiological limitations, it is not possible to know exactly where a person is looking by monitoring the position of the eye. The eye has the capability to focus on objects off center of where the eye is pointing. If the eye tracking software places the computer cursor in the center of the eye's field of view, the cursor may be misaligned from where the user is actually looking. Other offsets occur because of eye tracking hardware limitations that introduce other inaccuracies when measuring where the user is eye pointing. A cursor that is positioned differently from where the user is looking is confusing, because it means that the user will have to offset where she is looking to get the cursor over the letter she desires.

One way to address this offset problem has been to simply highlight the circumference of a targeted key, instead of displaying the cursor on the key. This allows people who use theirs eyes for accessing the keys to concentrate on just the letter and not worry if the cursor position located within the letter area. This approach overcomes issues related to aligning the cursor with a person's eye gaze and works fine as long as the keys are physically separated enough to prevent confusion between adjacent keys. The disadvantage is that the keyboard must be fairly large, using much of the computer display area for keyboard purposes.

While the process of selecting keys using dwelling has been used for many years, recently a software program named Dasher introduced a cursor typing technique that allows the user to select text by moving the cursor toward letters displayed on the right side of the program window as illustrated in FIG. 4. As the user moves the cursor toward the desired letter, the letter (followed by other letters that make up words in the English language) moves toward the left side of the screen. As letters move past the black vertical center line, they are entered into the text box at the top of Dasher. While Dasher removes the need to dwell, it still requires accurate cursor control.

Another input method introduced by Clifford Kushler from ForWord Input, Inc. demonstrated a new pen-input method for PDAs where a user can input data into the PDA using a continuous stroke of a pen to select letters on an onscreen keyboard. It is not clear whether this has application to eye pointing or not.

What is needed is a low-cost, practical, and accurate eye tracking system and method which would allow users to easily track eye movement and would provide severely handicapped users with the ability to accurately and easily input characters to an electronic device.

### SUMMARY OF THE INVENTION

According to one aspect, the present invention provides an eye tracking system which tracks a gaze point of a user, the system comprising a head tracking system which determines the location and orientation of the head of the user, an eye tracking system which determines the location and orientation of the eye of the user, a display device which presents a calibrating image to the user, and a processor which calculates the location of the center of rotation of the eye and the location of the gaze point of the user based on the location and orientation of the head of the user, the location and orientation of the eye, and the location of a plurality of calibration points presented within the calibrating image.

According to another aspect, an eye tracking method for locating the gaze point of a user is provided. The method comprises determining the location and orientation of the head of the user, determining the location and orientation of an eye of the user, presenting a calibrating image to the user, the calibrating image having calibration points, calculating the location of the center of rotation of the eye, and calculating the location of the gaze point of the eye based on the location and orientation of the head, the location and orientation of the center of the eye, the location of the calibration points, and the location of the center of rotation of the eye.

The present invention further provides a method for inputting to an electronic device a character selected by a user controlling a cursor, the method comprising displaying an array of characters, the array of characters comprising keys having multiple characters displayed thereon, placing the cursor near the character to be selected by the user, shifting the characters on a set of keys which are closest to the cursor such that characters not at similar positions on adjacent keys move in different directions and characters on the same key move in different directions, tracking the movement of the character to be selected with the cursor, and identifying the character to be selected by comparing the direction of movement of the cursor with the direction of movement of the characters of the set of keys which are closest to the cursor.

### BRIEF DESCRIPTION OF THE DRAWINGS

These and other more detailed and specific features of the present invention are more fully disclosed in the following specification, reference being had to the accompanying drawings, in which:

FIG. 1 shows a schematic of the eye of a user of an eye tracking system which monitors the position and movement of the user's eye by tracking the center of the pupil and a reflection of a light off the cornea of the eye.

FIG. 2 shows the electrodes in contact with the face of a user of an eye tracking system based upon the measurement of electrical signals generated by eye movements.

FIG. 3 shows a screen shot of an onscreen keyboard that is included with Microsoft Windows XP.

FIG. 4 shows a program window of a program utilizing a typing technique that allows the user to select text by moving the cursor toward letters displayed on the right side of the program window.

FIG. 5 shows an embodiment of an eye tracking system according to an embodiment of the invention.

FIG. 6 shows a head tracking apparatus coupled to the head of a user.

FIG. 7A shows an access area where the fields of view of two camera's overlap as seen from above according to an embodiment of the invention.

FIG. 7B shows a three-dimensional access area where the fields of view of two camera's overlap according to an embodiment of the invention.

FIG. 7C shows a grid pattern of an access area correlating to the field of view for each image capture row sensor.

FIG. 8 shows the head of a user positioned in an access area where the image of the head of the user is reflected from reflectors and captured by cameras coupled to the display device.

FIG. 9 shows a head tracking apparatus comprising markers coupled individually to the head of the user according to an embodiment of the invention.

FIG. 10 shows a cross section of an eye tracking device including a contact lens having a marker.

FIGS. 11A and 11B show steps of the calibration technique to calculate the center of rotation of the eyeball.

FIG. 12 shows the proportions of an arrangement of an eye tracking system according to an embodiment of the invention.

FIG. 13 shows the proportions of an arrangement of an eye tracking system and the limitations of an access area according to an embodiment of the invention.

FIG. 14 shows the number of detectable points of an access area according to an embodiment of the invention.

FIG. 15 shows the trigonometric relations used to calculate the gaze point of the user.

FIG. 16 illustrates a layout for an on-screen keyboard according to an embodiment of the invention.

FIGS. 17A and 17B illustrates a layout for an on-screen keyboard in relation to the image of a display device.

FIGS. 18A-18D illustrate steps taken to select a character according to an embodiment of the invention.

FIG. 19 illustrates a flow diagram of the steps of an embodiment of the method for inputting to an electronic device a character selected by a user.

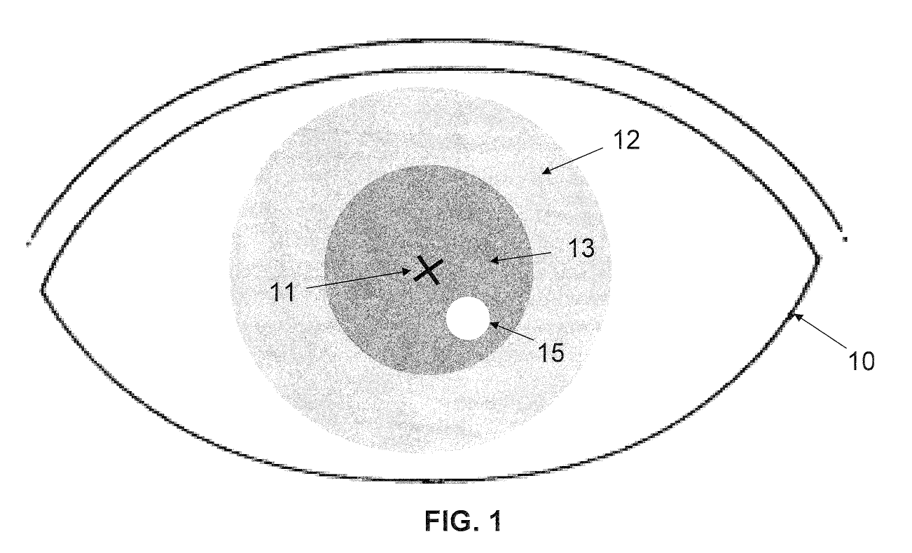

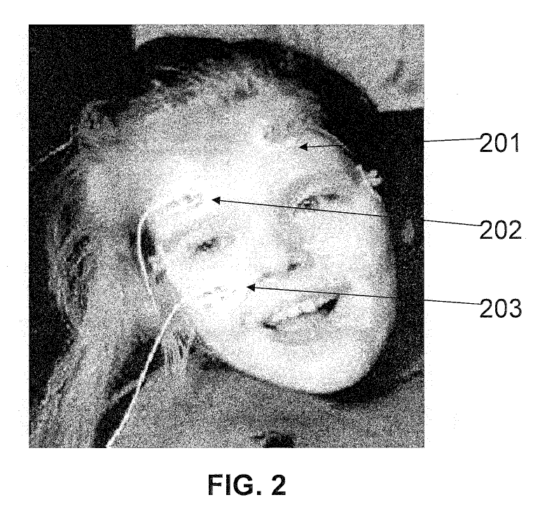

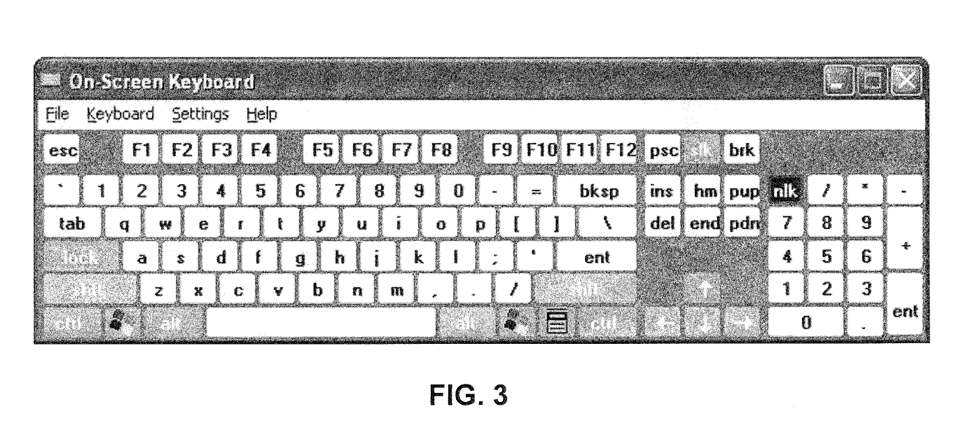

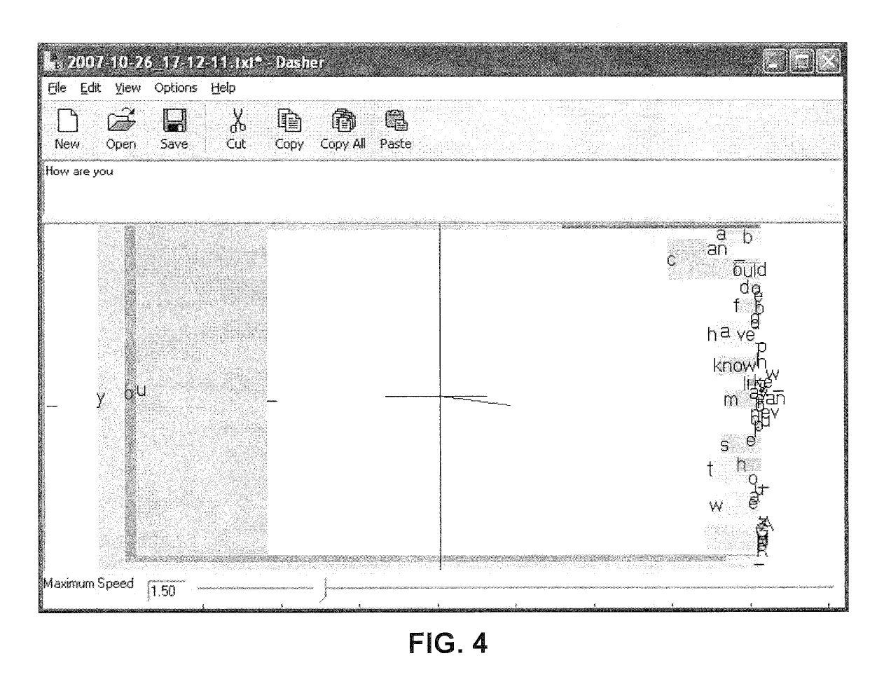

### DETAILED DESCRIPTION OF THE INVENTION

In the following description, for purposes of explanation, numerous details are set forth, such as system configurations and flowcharts, in order to provide an understanding of one or more embodiments of the present invention. However, it is and will be apparent to one skilled in the art that these specific details are not required in order to practice the present invention.

An example described herein is an eye tracking system that tracks a gaze point of a user, with the system comprising a head tracking system which determines the location and orientation of the head of the user, an eye tracking system which determines the location and orientation of the eye of the user. This, for example, may be undertaken by tracking the location and orientation of the pupil, and for ease of discussion this example is described further below, although positions offset from the pupil could also be used to similarly determine location and orientation. The system also comprises a display device which presents a calibrating image to the user, and a processor which calculates the location of the center of rotation of the eye and the location of the gaze point of the user based on the location and orientation of the head of the user, the location and orientation of the center of the eye, and the location of a plurality of calibration points presented within the calibrating image.

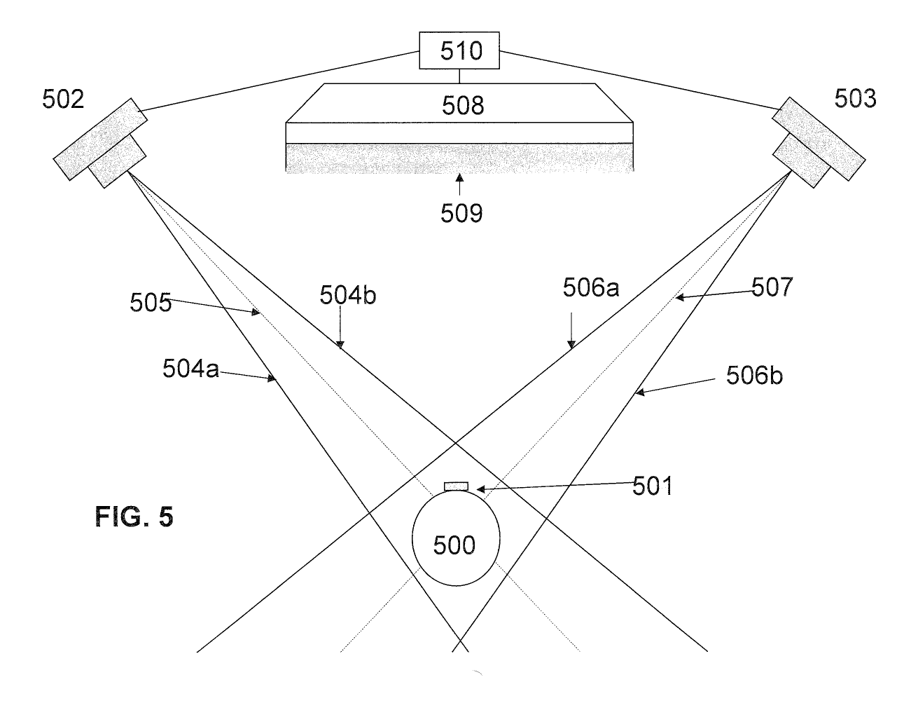

An eye tracking system according to an embodiment of the invention is illustrated from above in FIG. 5. According to this embodiment, the eye tracking system comprises a head tracking system comprising a head tracking apparatus 501 coupled to the head of user 500, an image capture apparatus comprising two image capture devices 502, 503, and a processor 510; an eye tracking system comprising an eye tracking device (not shown) coupled to an eye of user 500, an image capture apparatus comprising two image capture devices 502, 503, and a processor 510; a display device 508 which presents a calibration image 509 in front of a user 500; and a processor 510 which calculates the location of the center of rotation of the eye and the location of the gaze point of the user based on the location and orientation of the head of the user, the location and orientation of the center of the pupil, and the location of a plurality of calibration points presented within the calibrating image.

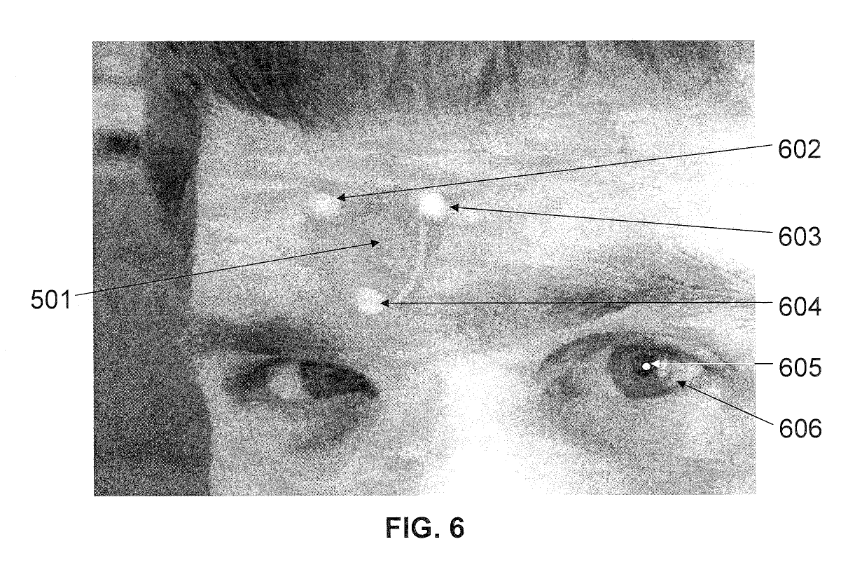

While there are many different ways to determine the location and orientation of the head of a user, according to this embodiment, the head tracking system comprises a head tracking apparatus 501, as shown in FIG. 6, has an example of markers in the form of retroreflective dots 602, 603, 604 coupled to the head of the user. In this particular embodiment, retroreflective dots 602, 603, 604 have a diameter of 4 mm.

Also shown in FIG. 6, an eye tracking device 605, coupled to eye 606 of the user, has a marker (again, the marker may be a retroreflective dot in this example) centered on the pupil of the eye. In this embodiment, eye tracking device 605 comprises a contact lens with an 800 μm diameter retroreflective dot centered in the contact lens. The retroreflective dot is small enough that the eye naturally looks around it, but the retroreflective dot reflects enough light back to image capture devices 502, 503 that they can accurately determine the location of the lens.

The eye tracking device 605, therefore, provides a fourth retroreflective dot that is centered on the pupil. When the user moves eye 606 relative to retroreflective dots 602, 603, 604, the eye motion is detected by image capture device 502, 503 and measured by processor 510.

As shown in FIG. 5, the head of user 500 is positioned within both the field of view 504a (left) to 504b (right) of the point of view 505 of image capture device 502 and the field of view 506a (left) to 506b (right) of the point of view 507 of image capture device 503.

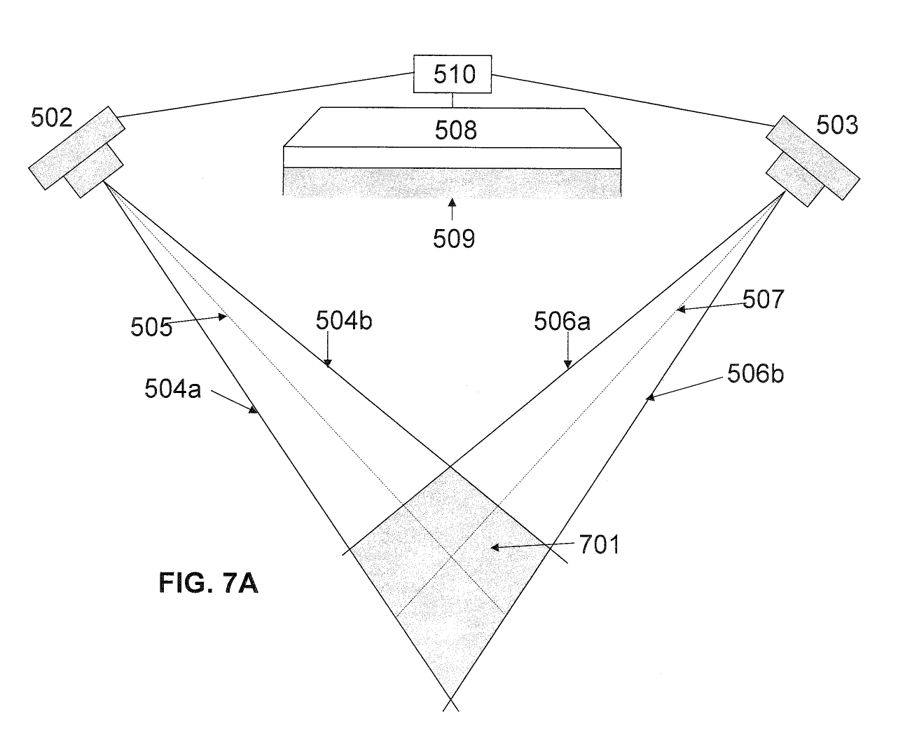

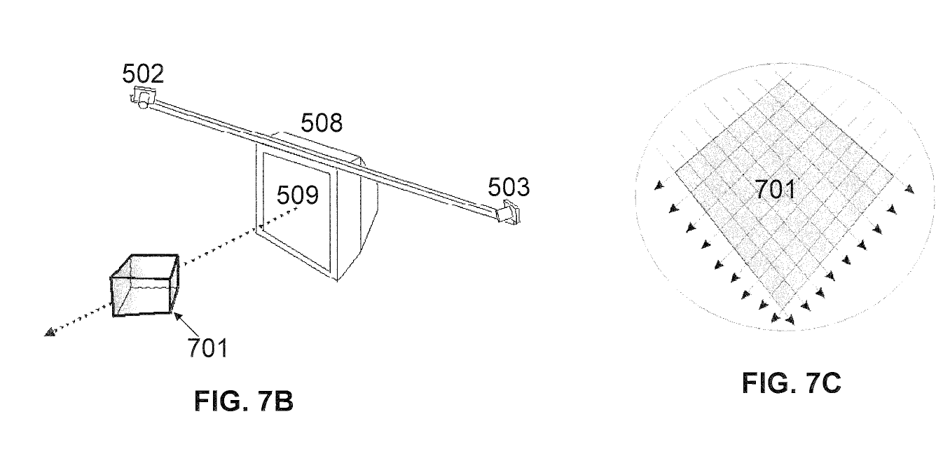

As shown in FIG. 7A, the area where field of view 504a to 504b and field of view 506a to 506b overlap creating, when seen two-dimensionally from above, a diamond shaped access area 701. When the head of user 500 is positioned within access area 701, it is possible to view the head of user 500 in both image capture devices 502, 503. Accordingly, both head tracking apparatus 501 and eye tracking device 605 are within the field of view of both image capture devices 502, 503.

Image capture devices 502, 503 are aligned so that access area 701 is a three-dimensional diamond shape in front of display device 508, as illustrated in FIG. 7B. Access area 701 may have the approximate dimensions of 12 inches×12 inches×8 inches.

In order to be imaged by both image capture devises 502, 503 the retroreflective dots of the head tracking and eye tracking devices must remain in the access area. Normal repositioning of a user to maintain comfort can easily be accomplished within the access area. Once the user calibrates the system, no recalibration is necessary unless the location of the retroreflective dots of the head tracking apparatus are altered with respect to the head of the user.

In another embodiment, as an alternative to mounting the image capture devices 502, 503 far apart, on either side of display device 508, as shown in FIG. 5, image capture devices 502, 503 are coupled to both processor 510 and image display device 508. Reflectors 812, 813 are positioned on opposite sides of display device 508. Reflectors 812, 813 reflect the images which are captured by image capture devices 502, 503. This arrangement simplifies the electronic design of the system.

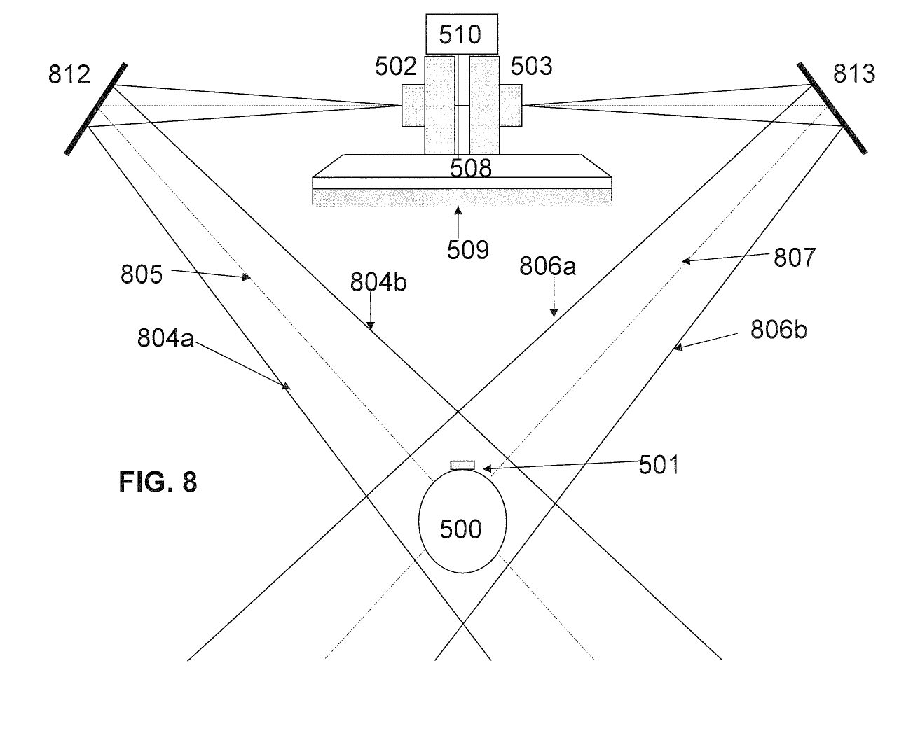

In another embodiment, as shown in FIG. 9, the head tracking apparatus may comprise retroreflective dots 901, 902, 903 coupled individually to the head of the user.

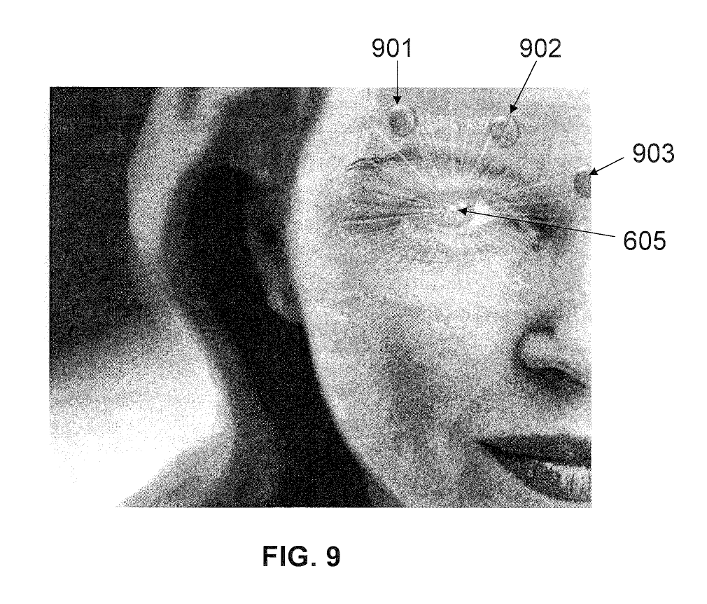

In another embodiment, as shown in FIG. 10, an eye tracking device 100 is comprised of a standard contact lens “button” 101 and a reflective micro-dot 102. Eye tracking device 100 is formed by boring a hole into the contact lens button 101 and inserting a thin, retroreflective material into the hole. According to this embodiment, the retroreflective material may comprise glass microspheres coupled to a reflective surface. The retroreflective material is then encapsulated with a monomer mixture and polymerized.

This process can be enhanced by tinting the monomer of reflective micro-dot 102 so that it passes infrared light but not visible light, making the color of the material in front of the retroreflective dot appear black, but not affecting the visibility of the retroreflective dot to the infrared cameras. Such a tint may add to the cosmetic appeal of the lens since the pupil will look more normal to people interacting with the user. Once the retroreflective material is encapsulated the lens can be cut to include a prescription.

In another embodiment, the eye tracking device comprises a retroreflective ring around the pupil. In another embodiment, the eye tracking device comprises a retroreflective dot or dots at a known offset from the center of the pupil.

Further, the eye tracking system may utilize imaging techniques to recognize the pupil, either using “red eye” techniques or looking for the black pupil at the center of the iris.

In another embodiment, low-cost, one mega-pixel cameras, in conjunction with custom electronics, can be used as image capture devices. Such cameras may track up to 8 retroreflective dots simultaneously.

In another embodiment, the image capture devices may be an infrared camera or cameras. In another embodiment, the image capture devices may be a visible light camera or cameras.

It is also noted that other elements may be substituted for the retroreflective dots as the markers. For example, the markers may also be implemented with LEDs instead of retroreflective spheres.

An eye tracking method for locating the gaze point of a user will now be described. The method comprises the steps of determining the location and orientation of the head of the user, determining the location and orientation of the pupil of an eye of the user, presenting a calibrating image to the user, the calibrating image having calibration points, calculating the location of the center of rotation of the eye, and calculating the location of the gaze point of the eye based on the location and orientation of the head, the location and orientation of the center of the pupil of the eye, the location of the calibration points, and the location of the center of rotation of the eye.

Generally, head-tracking devices use a single retroreflective dot to monitor head movement. These devices make no effort to distinguish between lateral head movement and head rotation. Because it is necessary to accurately measure eye movement with respect to the head, it will be important for us to know the exact position of the head within the access area. To accomplish this, the user is required to wear a head tracking apparatus having a three retroreflective devices coupled to the head of the user. The use of three retroreflective dots enables the system to exactly determine the three-dimensional location and orientation of the head. While the position of the retroreflective dots on the head is not critical, they must be placed on the user so that they are visible to the image capture devices.

The description below focuses on locating the position of the retroreflective dots in two-dimensional (x,y) space for illustration purposes. The extension of the method to three dimensions (x,y,z) is a process of visualizing the approach over multiple layers of camera sensor rows.

In an image capture device, such as a camera, each sensor within a camera row effectively “sees” a small section of the overall camera field of view. Within the access area, which is in the field of view for both cameras, a grid pattern correlating to the field of view for each camera row sensor is established as illustrated in FIG. 7C. When a retroreflective dot moves, the sphere intersects the view of different sensors within a row of the camera. Accordingly, the exact position of a sphere can be calculated as it moves between grid locations. Using three spheres and principles of trigonometry enables the system to determine the exact position and orientation of the head within the access area. It is not possible for the user to move without moving at least one of the spheres.

Using the retroreflective dot coupled to the eye tracking device, this same grid and principles of trigonometry are used to determining the location of the center of the pupil of the eye with respect to the head. However, in order to calculate the gaze point of the eye, it is necessary to determine the location of two sites on the eye. Having the location of one point, i.e. the center of the pupil, the second point is located by calculating the location of the center of rotation of the eye,

In order to calculate the center of rotation of the eye, the user correlates the position of the center of the pupil of the eye with locations on the display device. This is accomplished by a software calibration routine.

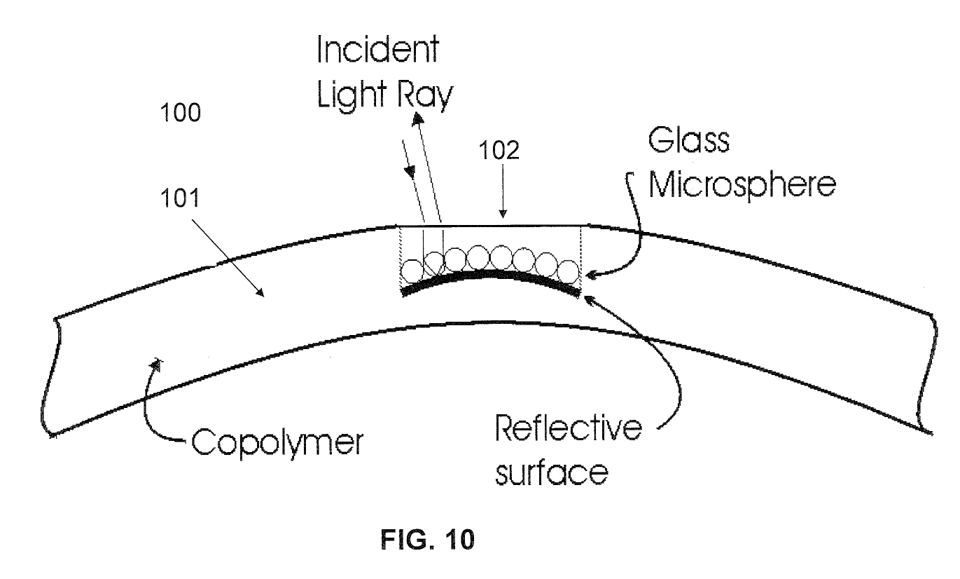

The user, wearing an eye tracking device, is asked by a software calibration routine to sequentially view multiple highlighted locations 111, 112 on the display 509, as shown in FIGS. 11A and 11B. As shown in FIG. 11A, the user views highlighted location 111. Knowing the position of highlighted location 111, the eye tracking system calculates, using trigonometric principals, the equation of the line from highlighted location to the pupil center 113. Then, as shown in FIG. 11B, the user views highlighted location 112 and the eye tracking system, using trigonometric principals, calculates the equation of the line from highlighted location to the pupil center 113. The intersection of the two line equations provides the location of the center of rotation 106 of the eye. It should be noted that the calibration software calculates the center of rotation 106 relative to the known locations of the retroreflective dots of the head tracking apparatus.

In another embodiment, the method can be completed for a user wearing one or two retroreflective contact lenses.

The gaze point of the eye can be calculated based on the location and orientation of the head, the location of the pupil center of the eye, and the location the center of rotation of the eye.

The approach described here uses the center of the contact lens (located on the cornea) for the first point, and the calculated center of rotation of the eye as the second point. Using a line from the center of rotation through the center of the pupil is the most mathematically efficient way to determine where the eye is pointing. Using this method enables the eye tracking system to use low cost cameras and electronics for tracking the eye.

After calibration, normal repositioning of a user to maintain comfort can easily be accomplished within the access area. Further, after calibration, the user can move freely in and out of the access area without recalibrating the system. Once the user calibrates the system, no recalibration is necessary unless the location of the retroreflective spheres on the user's head changes.

Additionally, in another embodiment, a custom electronics automatically determine the centroid of each retroreflective dot and transmits the location of each centroid up to 28 times per second to the processor. Calculating the centroid in hardware has three main benefits. First, the system is very fast. Second, the system does not have to transmit much image data to the processor. Third, calculating the centroid provides an improvement in system resolution when compared to the hardware resolution of the camera.

The following mathematical proofs are intended to provide background for the trigonometric principles described in this disclosure and to illustrate the methodology used to calculate the gaze point of the eye within the access area. The proofs and concepts are arranged in the following order: 1) an embodiment of the access area is characterized; 2) according to the characterization of the access area, the range of motion of the eye is characterized; 3) the accuracy of the eye-tracking system is calculated; and 4) the algorithm for calculating the gaze point of the eye.

It should be noted that the following proofs, concepts, assumptions, and dimensions are for purposes of explanation and are in no way limiting. Numerous configurations are offered, in order to provide an understanding of one or more embodiments of the present invention. However, it is and will be apparent to one skilled in the art that these specific details are not required in order to practice the present invention.

Several assumptions are necessary in order to determine the eye gaze resolution at a the image of the display device. These assumptions are made in order to provide a reasonable starting place for performing eye tracking. According to one embodiment, the following assumptions are made:

1) The average distance between the user and the display device is 30 inches, which provides for comfortable viewing. Most commercial/research eye gaze systems work at much closer distances (18 to 22 inches) in order to improve the resolution of the eye tracking system.

2) The image 509 of the display device 508 is a standard 19 inches (diagonal) and 14 inches wide, as in a common computer monitor.

3) An access area width of 12 inches is a reasonable width within which the retroreflective dots must remain in order to manipulate a cursor on the image of the display device.

4) The area on the user's head covered by the head tracking apparatus and eye tracking device is 3 inches wide by 2 inches high.

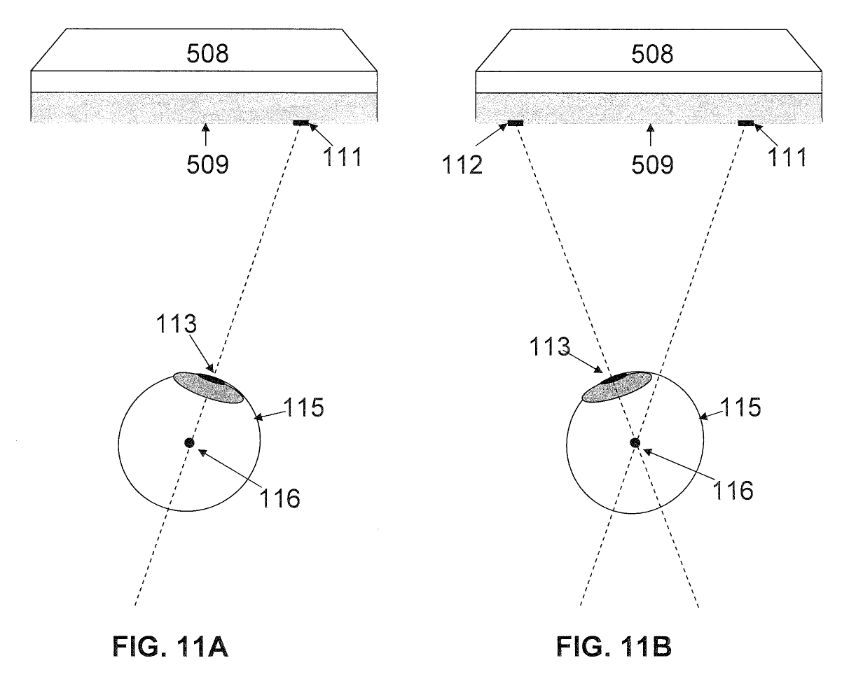

5) As shown in FIG. 12, the image capture devices 502, 503 will be mounted at so that their respective optical axes will be 45° angles to the plane of the surface of the image 509 of the display device 508. This arrangement provides the best geometry for the detection grid, see FIG. 7C. The image capture devices 502, 503 are separated by 60 inches (twice the user distance to the image of the display device) if the cameras are to be located in the same plane image 509.

FIG. 12 shows the calculation for determining the required field of view of the camera, as well as the depth and height of the access area given the assumptions above.

The diamond shape of the access area and the requirement that all the retroreflective dots must be visible to each image capture device means that some of the access area is not useable. The retroreflective dots can easily be placed on the user within the assumed 3 inch width. The width required for the dots reduces the 12 inches×12 inches access area to a practical head travel area of 9 inches wide×8.8 inches deep. The 9 inch width is determined by subtracting the width of the retroreflective dots from the access area width.

According to the parameters of the embodiment illustrated in FIG. 12, the required field of view for the image capturing devices is equal to:

(α−45°)×2=12.68°,

where α=tan−1 (30/24)=51.34° and σ=α−12.68°=38.66°.

The depth of the access areas is equal to:

d1+d2=12.3 inches,

where 6 inches/sin(90°−α)=d1/sin(α); d1=7.5 inches

and d2/sin(α)=6 inches/sin((90°−α)); d2=4.8 inches

The height of the access area (which is not visible in FIG. 12), where the aspect ration of the image capture device is 320×240 pixels, is equal to:

height on inside edge of the access area=√(6²+4.8²)×240/320=5.8 inches; and

height on outside edge of the access area=√(6²+7.5²)×240/320=7.2 inches

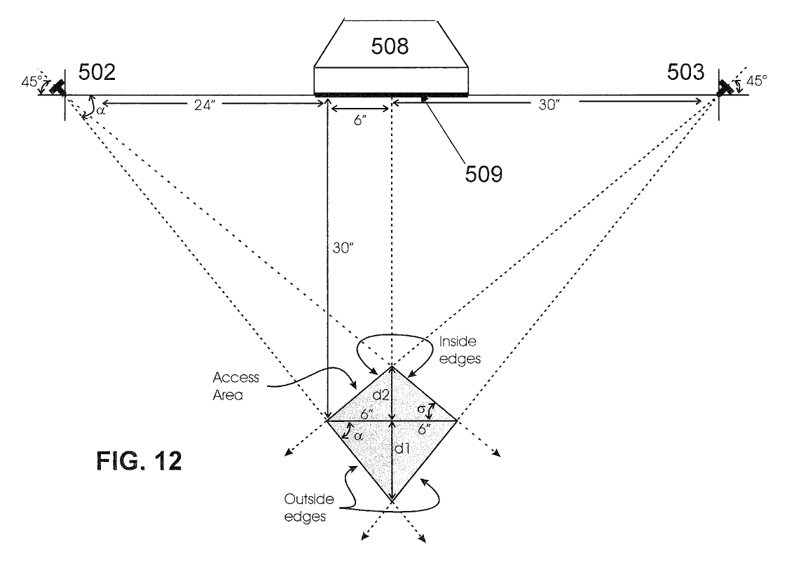

The 8.8 inch depth of the access area is determined by measuring the software version of the scaled FIG. 12 and limiting the access area so that all three retro-reflective dots are within the access area. FIG. 13 illustrates (in black) the area within which the user's head must remain.

In order to determine the resolution of the eye-tracking system, the amount of lateral eye movement 6 necessary when the user visually sweeps across the 14 inches width of the image 509 must be determined. Three calculations are useful, one when the eye is at the shortest distance to the image 509 (FIG. 13, 26.4 inches), one when the eye is at the widest section of the access area (FIG. 13, 30 inches), and one at the longest distance (FIG. 13, 35.2 inches). The following equations assume that the eyeball of the user is 1 inch in diameter and that the eyeball rotates about its center. These are both reasonable assumptions.

14 inches÷26.4 inches=δ÷0.5 inches; δ=265 mils (at closest distance to monitor)

14 inches÷30 inches=δ÷0.5 inches; δ=233 mils (at 30 inches distance to monitor)

14 inches÷35.2 inches=δ÷0.5 inches; δ=199 mils (at farthest distance from monitor)

The eye tracking accuracy is dependent upon the resolution of the image capture device. The resolution of the image capture device is dependent upon the centroid calculation method built into the image capture device. The following calculations assume a 10:1 enhancement in the resolution of the image capture devices due to calculating the centroid of each retroreflective dot and the contact lens.

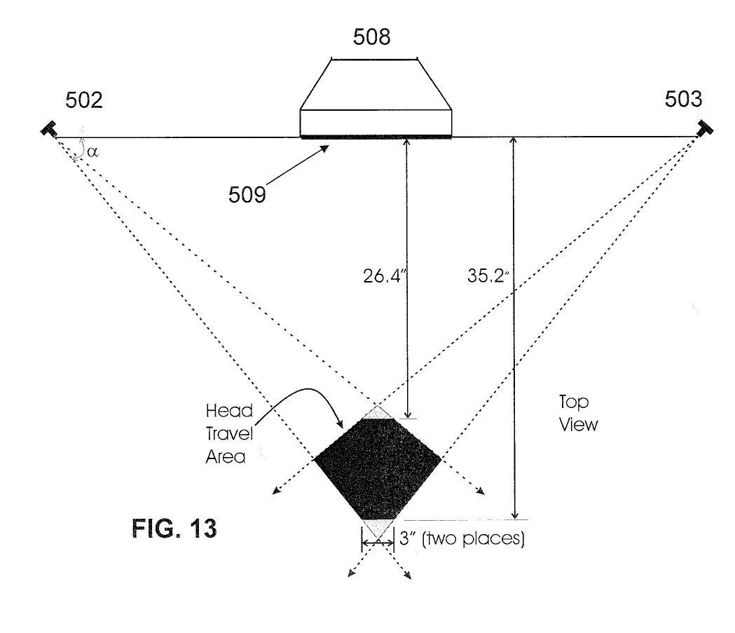

One benefit of using two image capture devices, as illustrated in FIG. 14, is that the resolution perpendicular to the plane of the monitor is equal to:

# of detectable points=2·(camera resolution)−1.

Given this property, the average eye-tracking accuracy at the widest point of the access area is equal to:

accuracy=(width of the access area)÷(# of detectable points)=12 inches÷((2·(320·10))−1)=1.9 mils, where:

12 inches=widest width of access area,

320=horizontal hardware resolution of the camera (320×240 pixels),

10=increase in resolution due to the centroid calculation algorithm (effective resolution=3,200), and

2=advantage of using two cameras.

Given the eye movement calculations above and the lateral eye-tracking accuracy, the average resolution when eye gazing to the monitor is calculated at three locations within the access area as specified below.

Eye-tracking accuracy÷Eye movement=Eye-gaze Resolution÷Width of monitor

At the closest distance to the monitor:

1.9 mils÷265 mils=c÷14 inches; where c=0.100 inches.

At the widest point of the access area:

1.9 mils÷233 mils=c÷14 inches; where c=0.114 inches.

At the farthest distance from the monitor:

1.9 mils÷199 mils=c÷14 inches; where c=0.133 inches.

In order to determine the location of the user's gaze point, the coordinates of the retroreflective dots of the head tracking apparatus and the retroreflective dot of the eye tracking device must be translated from the view of the image capture device to the Cartesian coordinates of the monitor. This is a straightforward translation since the view of each camera pixel is effectively equal to 1/3200 of the field of view of the camera. Thus, by knowing the angle at which the camera is mounted and the number of the camera pixel that is highlighted (or more accurately, the centroid of several pixels that are highlighted) it is possible to calculate the angle of the highlighted camera pixel relative to the plane of the monitor.

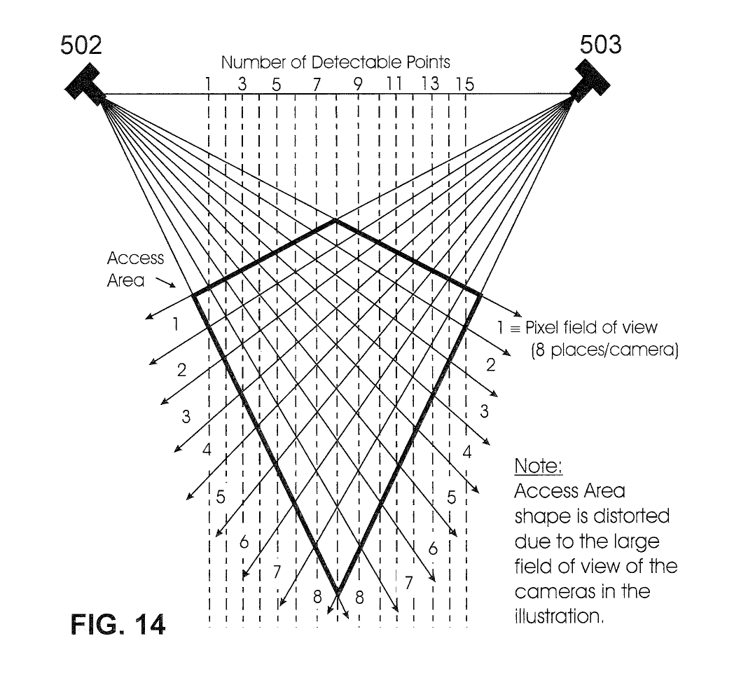

Given that the maximum camera angle is 51.34°, the resolution of the camera is 3200 (in the horizontal plane), and the field of view of the camera is 12.68°, the angle of each camera pixel (camera 1 angle=ε, camera 2 angle=β in FIG. 15) relative to the plane of the monitor is:

Camera pixel angle=51.34°−((camera pixel number÷3200)×12.68°).

Once the camera pixel angle is known for each camera, the coordinates of a retroreflective dot (I and J in FIG. 15) are calculated as shown in FIG. 15. With the distance between the image capture devices 502, 503 being 60 inches,

K=sin β×60 inches/sin(180°−ε−β),

I=cos ε×K,

J=sin ε×K.

The third dimension (the height) of each dot is calculated in a similar fashion.

At this point, equations (at least in two dimensions) have been provided for determining the position of each retroreflective surface in Cartesian coordinates referenced to the image of the display device 508. The only purpose of the three retroreflective dots is to define the location of the center of rotation of the eyeball of the user in 3-D space. The center of rotation is calculated during the calibration routine. As the user gazes at known highlighted locations on the monitor, it is possible to calculate the equation of the line defined by two points; the first point is the highlighted location on the monitor and the second point is the centroid of the contact lens. This line is referred to as the “calibration line.” If this process is repeated with several locations on the monitor all the calibration lines will have one point in common—the center of rotation of the eye. Once the center of rotation is determined, its relative position to the dots can be calculated.

It is important to note that the system does not require the head to remain fixed during calibration. As the position of the three retro-reflective dots change, it is possible to translate their new positions in space “back” to a previous position. As long as the same translation is performed on the position of the contact lens and the equation of the calibration line, the results are equivalent to holding the head stationary.

After the calibration routine is completed, the location of the center of rotation of the eye, relative to the location of the retro-reflective dots, is fixed. The image capture devices 502, 503 can also locate the centroid of the retroreflective device at the center of the pupil.

These two pieces of information are used to define a line that represents the line of sight of the eye. Once this equation is known, it can be solved at the plane of the image 509 to determine where the eye is looking on the image as follows. If P1 represents the coordinates of the center of the eye (i1, h1, j1) where the orientation of ‘i’ and ‘j’ are illustrated on FIG. 15 as I and J, and ‘h’ is the height of P1 relative to the position of image capture device 502, and similarly P2 represents the coordinates to the centroid of the retroreflective dot of the eye tracking device i2, h2, j2, then analytic geometry properties to solve for the direction cosines provide:

|P1P2|=√[(i2−i1)²+(h2−h1)2+(j2−j1)²]

cos ι=(i2−i1)÷|P1P2|

cos η=(h2−h1)÷|P1P2|

cos φ=(j2−j1)÷|P1P2|.

Once we have calculated the direction cosines, all that is required to find the x,y (or more accurately in the above example, the i,h) coordinates of the eye gaze point, P3, relative to the plane of image capture device 502 (and therefore the image 509) is:

|P1P3|=(j3−j1)÷cos φ; where j3=0 since we are in the plane of the image 509,

i3=cos ι·|P1P3|+i1,

h3=cos η·|P1P3|+h1.

Next is described a method for inputting to an electronic device a character selected by a user controlling a cursor, the method comprising displaying an array of characters, the array of characters comprising keys having multiple characters displayed thereon, placing the cursor near the character to be selected by the user, shifting the characters on a set of keys which are closest to the cursor such that characters not at similar positions on adjacent keys move in different directions and characters on the same key move in different directions, tracking the movement of the character to be selected with the cursor, and identifying the character to be selected by comparing the direction of movement of the cursor with the direction of movement of the characters of the set of keys which are closest to the cursor.

This method for inputting to an electronic device a character selected by a user controlling a cursor may be used in conjunction with an alternate input device, for example an eye point or head point system.

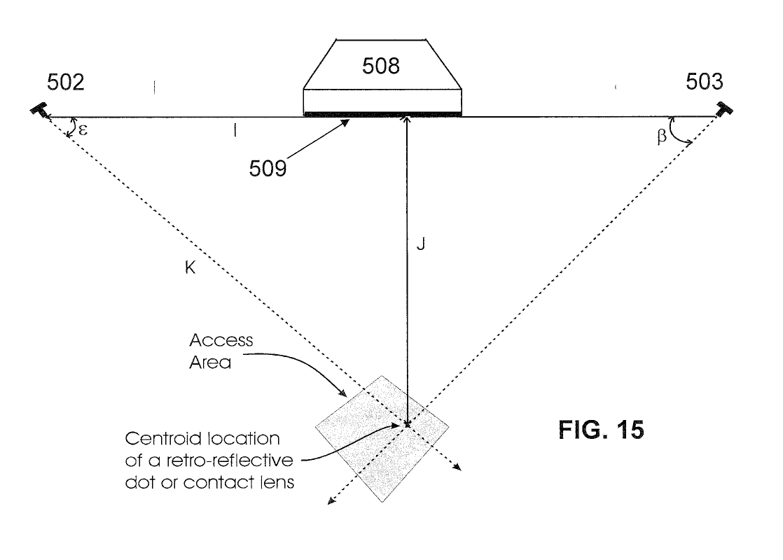

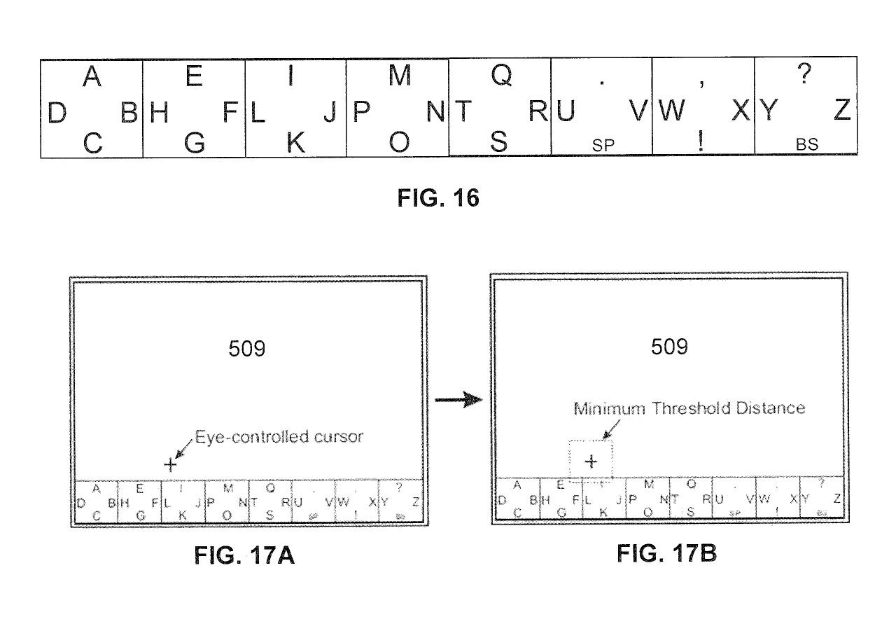

According to an embodiment of the invention, FIG. 16 illustrates a layout for an on-screen keyboard comprising eight square keys. Each key has four characters displayed on it, the characters being positioned at positions similar to other characters on other keys. Although alphanumeric characters are shown, the characters may alternatively be symbols, line drawings, or other types of characters. As shown in FIGS. 17A and 17B, the on-screen keyboard reduces the total area of the image 509 of the of the display device. However, the keys must be sufficiently large enough that the eye tracking system can easily distinguish between characters at similar positions on adjacent keys, for example, the “A” and the “E”.

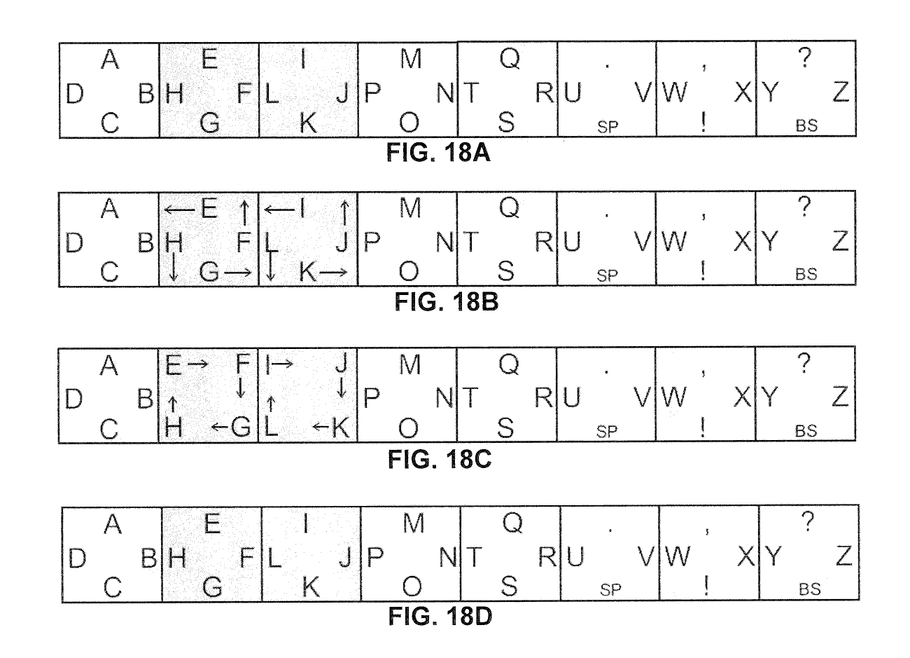

When the user gazes at a character on the on-screen keyboard, the keys nearest to the gaze point are highlighted, as shown in FIG. 18A. Shortly thereafter, the characters of the set of keys nearest to the calculated gaze point are shifted in a unique direction such that characters not at similar positions on adjacent keys move in different directions and characters on the same key move in different directions. For example, as shown in FIG. 18B, character “F” is shifted up while character “L” is shifted down, or character “G” is shifted to the right while character “F” is shifted up.

As the characters move, the user is required to follow the desired character with his eye gaze. The movement of the eye gaze is monitored to determine which character the user is following. Then, the movement of the eye gaze is compared to the movement of the various characters of the highlighted keys to determine which character the user was gazing at.

Additionally, in another embodiment, the system may then confirm the determination by moving the characters on the keys back to their original position, as shown in FIGS. 18C and 18D. If the eye movement corresponds to the movement of the same character, the on-screen keyboard sends the character to the active software application. In addition to shifting the characters about the center of the keys, the characters can also be shifted in various other directions such as drawing the characters of the highlighted keys into the middle of their respective keys. Any shifting scheme could be used so long as characters not at similar positions on adjacent keys move in different directions and characters on the same key move in different directions.

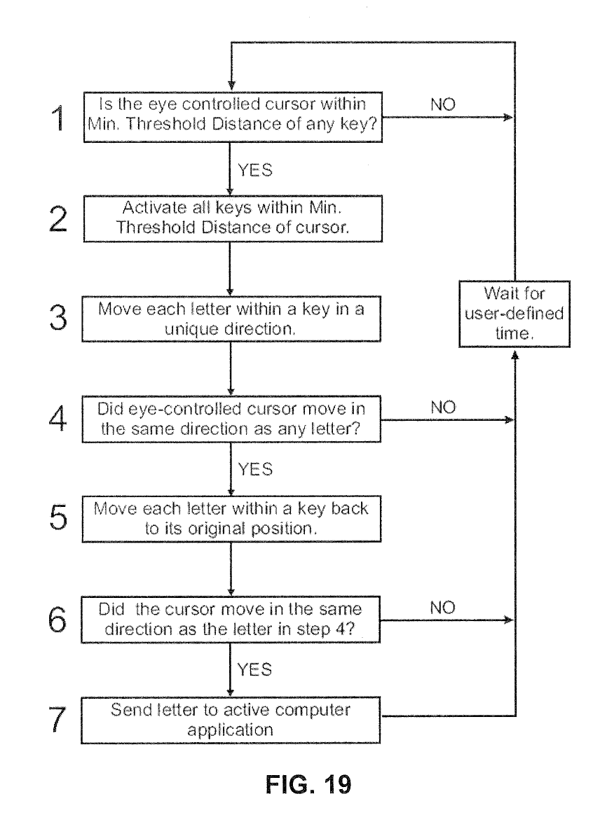

The steps of an embodiment of the method for inputting to an electronic device a character selected by a user with the use of an eye tracking system are shown in the flow diagram of FIG. 19.

While in FIGS. 16, 17A-17B, and 18A-18D the characters on the keys comprise general letters, numbers, punctuation marks, and commands (“BS” for “backspace” and “SP” for “space”), it should be understood that the term character, as used in this disclosure, may be any letter, number, pictograph, command, icon, object, sign, or symbol, etc., which may be selected by a user.

According to another embodiment, the above methods for inputting to an electronic device a character selected by a user is performed with the use of an eye tracking system comprising a head tracking system which determines the location and orientation of the head of the user, an eye tracking system which determines the location and orientation of the pupil of an eye of the user, a display device which presents a calibrating image to the user, and a processor which calculates the location of the center of rotation of the eye and the location of the gaze point of the user based on the location and orientation of the head of the user, the location and orientation of the pupil, and the location of a plurality of calibration points presented within the calibrating image.

According to another embodiment, the above methods for inputting to an electronic device a character selected by a user with the use of an eye tracking system further comprises tracking the eye gaze of the user by determining the location and orientation of the head of the user, determining the location and orientation of the pupil of an eye of the user, presenting a calibrating image to the user, the calibrating image having calibration points, calculating the location of the center of rotation of the eye, and calculating the location of the gaze point of the eye based on the location and orientation of the head, the location and orientation of the center of the pupil of the eye, the location of the calibration points, and the location of the center of rotation of the eye.

While the invention has been described with respect to a various embodiments thereof, it will be understood by those skilled in the art that various changes in detail may be made therein without departing from the spirit, scope, and teaching of the invention. Accordingly, the invention herein disclosed is to be limited only as specified in the following claims.

1. An eye tracking system which tracks a gaze point of a user, said system comprising:
a head tracking system which determines the location and orientation of the head of said user;
an eye tracking system which determines the location and orientation of an eye of said user;
a display device which presents a calibrating image to said user; and
a processor which calculates the location of the center of rotation of said eye and the location of the gaze point of said user based on the location and orientation of the head of said user, the location and orientation of the center of said eye, and the location of a plurality of calibration points presented within the calibrating image.

2. The eye tracking system of claim 1, wherein said head tracking system includes:
a head tracking apparatus having a plurality of markers coupled to the head of said user; and
an image capture device which captures image data of said markers of said head tracking apparatus from a plurality of points of view.

3. The eye tracking system of claim 2, wherein said processor calculates the location and orientation of the head of said user based on the image data captured by said image capture device;
wherein said markers of said head tracking apparatus are within the field of view of each point of view of said image capture device, and
wherein the fields of view of each point of view overlap in the area where said head tracking apparatus is positioned.

4. The eye tracking system of claim 1, wherein said an eye tracking system includes:
an eye tracking device having a marker that indicates the orientation of said eye; and
an image capture device which captures image data of said marker of said eye tracking device from a plurality of points of view.

5. The eye tracking system of claim 4, wherein said processor calculates the location and orientation of said eye based on the image data captured by said image capture device;
wherein said marker of said eye tracking device is within the field of view of each point of view of said image capture device, and
wherein the fields of view of each point of view overlap in the area where said eye tracking device is positioned.

6. The eye tracking system of claim 2, wherein said image capture device includes a plurality of cameras, said cameras being positioned at different positions relative to said calibrating image.

7. The eye tracking system of claim 4, wherein said image capture device includes a plurality of cameras, said cameras being positioned at different positions relative to said calibrating image.

8. The eye tracking system of claim 4, wherein said eye tracking device comprises a contact lens to which said marker is coupled.

9. An eye tracking method for locating the gaze point of a user, said method comprising the steps of:
determining the location and orientation of the head of said user;
determining the location and orientation of an eye of said user;
presenting a calibrating image to said user, said calibrating image having calibration points;
calculating the location of the center of rotation of said eye; and
calculating the location of the gaze point of said eye based on the location and orientation of the head, the location and orientation of said eye, the location of the calibration points, and the location of the center of rotation of said eye.

10. The eye tracking method of claim 9, wherein determining the location and orientation of the head of said user further comprises coupling to the head of said user a head tracking apparatus having a plurality of retroreflective dots.

11. The eye tracking method of claim 10, wherein determining the location and orientation of the head of said user further comprises capturing image data of said retroreflective dots of said head tracking apparatus from a plurality of points of view with overlapping fields of view.

12. The eye tracking method of claim 9, wherein determining the location and orientation of said eye further comprises coupling to said eye an eye tracking device having a retroreflective dot.

13. The eye tracking method of claim 12, wherein determining the location and orientation of said eye further comprises capturing image data of said retroreflective dot coupled to said eye from a plurality of points of view with overlapping fields of view.

14. The eye tracking method of claim 13, wherein determining the location and orientation of said eye is based on the captured image data in relation to the determined location and orientation of the head of said user.

15. The eye tracking method of claim 8, wherein calculating the location of the center of rotation of said eye further comprises:
presenting a calibrating image in front of said user;
viewing sequentially a plurality of highlighted locations on said image;
determining the location of said eye while said user is viewing each highlighted location;
calculating the equation of each line from each highlighted location through the orientation of said eye; and
calculating the location of the center of rotation based on the point of intersection of the lines.

16. A method for inputting to an electronic device a character selected by a user controlling a cursor, said method comprising:
displaying an array of characters, said array of characters comprising keys having multiple characters displayed thereon;
placing the cursor near the character to be selected by said user;
shifting the characters on a set of keys which are closest to the cursor such that characters not at similar positions on adjacent keys move in different directions and characters on the same key move in different directions;
tracking the movement of the character to be selected with the cursor; and
identifying the character to be selected by comparing the direction of movement of the cursor with the direction of movement of the characters of said set of keys which are closest to the cursor.

17. The method of claim 16, wherein the cursor is controlled by the user through eye pointing and tracking the gaze point of said user.

18. The method of claim 16, wherein the cursor is controlled by the user through head pointing and tracking the head point of said user.

19. The method of claim 16, wherein shifting the characters on a set of keys which are closest to the cursor comprises rotating the characters of the keys about the center of their respective key.

20. The method of claim 16, further comprising:
highlighting the keys of said set of keys which are closest to the cursor.

21. The method of claim 16, further comprising:
shifting the characters on said set of keys back to their original position;

22. The method of claim 16, further comprising:
tracking the gaze point of said user using the eye tracking system according to claim 1.

23. The method of claim 16, wherein tracking the gaze point of said user includes the method according to claim 9.
